(19) United States
(12) Patent Application Publication
(10) Pub. No.: US 2024/0360033 A1
(43) Pub. Date: Oct. 31, 2024

(54) ASSEMBLY FOR REDUCING CO2 EMISSION IN PLANTS FOR CLINKER PRODUCTION

(71) Applicants: POLITECNICO DI MILANO, Milano MI (IT); Laboratorio Energia Ambiente Piacenza and Società Consortile a Responsabilità Limitata enunciabile, Piacenza PC (IT)

(72) Inventors: Matteo Carmelo ROMANO, Piacenza PC (IT); Edoardo DE LENA, Guglionesi CB (IT); Maurizio SPINELLI, Piacenza PC (IT)

(21) Appl. No.: 18/418,837

(22) Filed: Jan. 22, 2024

Related U.S. Application Data
(63) Continuation of application No. PCT/IB22/56756, filed on Jul. 21, 2022.

(30) Foreign Application Priority Data
Jul. 22, 2021 (IT) 102021000019547

(51) Int. Cl. C04B 7/36; B01D 53/62; B01D 53/81; C04B 7/43; C04B 7/44; C04B 7/47; F27B 7/00; F27B 15/00

(52) U.S. Cl. CPC C04B 7/367; B01D 53/62; B01D 53/81; C04B 7/434; C04B 7/44; C04B 7/47; F27B 7/00; F27B 15/00; B01D 2251/404; B01D 2251/602; B01D 2257/504; B01D 2258/0233; F27M 2003/03

(57) ABSTRACT

The invention concerns:
A) An assembly to reduce the emission of CO₂ in a plant for the production of clinkers comprising two calciners and a carbonator arranged between the two calciners, wherein one of the calciners is an integral part of a conventional clinker production system. Thanks to this assembly, the plant can continue to operate in the clinker production process even if the CO₂ capture system which uses the carbonator and the other calciner of the assembly is disconnected due to malfunctions or maintenance characterized in that said carbonator is free of recirculation to both said two calciners.
B) The relative plants comprising both the assembly and the actual clinker production plant in which the clinker production plant is of the conventional type existed before and already operational, or said plant is installed simultaneously with the assembly units.
C) The clinker production process with reduction of CO₂ emission conducted in the plants B.

### FIELD OF THE INVENTION

The present invention relates to an assembly to reduce the emission of CO₂, the relative plants for the production of energy containing the aforesaid assembly and the processes for the production of clinkers conducted in said plants.

### BACKGROUND ART

The use of processes and relative plants (an example of which is shown in FIG. 1) to produce clinker, the main constituent of cement, is known from the state of the art. The clinker produced is a mixture of calcium-silicate compounds and almost all the CO₂ emissions of the cement industry are linked to the production thereof. The raw materials (or “raw meal”) are mixed and ground in a mill (“raw mill”), preheated in a cyclone preheater (“preheater”), calcined in a calciner (“calciner”) at about 850-950° C., heated at about 1400-1500° C. in a rotary kiln (“rotary kiln”) in which the clinker is formed and finally the clinker is cooled in a cooler (“cooler”). In the described process it is necessary to burn fuel in the following two areas:
(i) In the calciner, to provide heat for the decomposition of the calcium carbonate contained in the raw materials in CaO and CO₂ according to the following reaction called “calcination”: CaCO₃→CaO+CO₂
(ii) In the rotary kiln, to heat the material to high temperatures and allow the formation reactions of the clinker to occur.

The formation and the emission of CO₂ in a plant for the production of clinkers is associated with the following processes:
(i) The decomposition of calcium carbonate according to the calcination reaction, which accounts for about 60% of the total emissions;
(ii) The combustion of fuel in the calciner and in the rotary kiln, which accounts for about 40% of the total emissions (of which approximately 50-60% from combustion in the calciner and 40-50% from combustion in the rotary kiln).

In the state of the art, different methodologies have been used to reduce these emissions, such as the use of low-carbon fuels (such as natural gas) or the use of biomass (with a neutral impact on CO₂ emissions), improving the energy efficiency of the plants, reducing the clinker/cement ratio [1]. Nevertheless, the potential reduction of CO₂ emissions using these techniques is limited as the above-mentioned methodologies are not able to reduce the CO₂ emitted by the raw material calcination, which, as mentioned before, accounts for about 60% of the total emissions of a plant. To achieve significant reductions in CO₂ emissions, it is therefore essential to adopt CO₂ capture and storage (Carbon Capture and Storage—CCS) systems.

Among the various known technologies proposed for the abatement of greenhouse gases in the cement industry, some of the most promising are based on the Calcium Looping (CaL) system. This process is based on the use of calcium oxide (CaO) as a sorbent for the removal of CO₂ from a gas stream, according to the reversible carbonation-calcination reaction:

$$CaO + {CO}_{2} ⇌ {CaCO}_{3} ( Δ {H}_{298 K}^{0} = - 179.2 \frac{kJ}{k {mol}_{CO 2}} )$$

FIG. 2 shows a simplified block diagram of a CaL system. The gases rich in CO₂ are introduced into a carbonator, in which they come into contact with a mixture of solids with a high CaO content and a temperature of about 650° C. The exothermic carbonation reaction takes place in this reactor and CO₂ is separated from the gas stream. The solids, enriched with calcium carbonate (CaCO₃) formed during carbonation, are sent to a second reactor (the calciner) for regeneration at about 900-950° C. The heat required for calcination is provided by combustion of a fuel (preferably a solid fuel such as coal, biomass, waste fuel) with a low-nitrogen oxidizer (typically O₂ produced in an air separation system, in a mixture with recirculated CO₂), in order not to nullify the separation of CO₂ by diluting it with the nitrogen present in a classic combustion with air. The CO₂-rich stream exiting from the calciner is then cooled, purified and compressed and thus brought to the conditions suitable for the geological transport and storage thereof. The regenerated solids rich in CaO exiting from the calciner are sent back into the carbonator, thus closing the “loop”. One of the main advantages of the CaL systems is that much of the chemical energy contained in the fuel and used in the calciner can be efficiently recovered at a high temperature and converted into electricity with high yields. In order to maintain an adequate CO₂ capture capacity by the solids, it is necessary to provide a CaCO₃ make-up stream and a purge stream, to avoid the accumulation of inert material, ash and sulfur in the system and to maintain a good activity of the sorbent. The CaL process has been successfully demonstrated on plants sized up to 1-1.7 MWₜₕ operating under representative conditions for integration into thermoelectric power plants [2,3]. Further advantages are obtained if the CaL systems are integrated into the cement industry, thanks to the existing synergies between the two processes. In fact, both processes use solids rich in CaCO₃ as raw material. There is therefore an easy supply of on-site material and it is further possible to enhance the purge of the CaL system by using it directly for the production of the clinker.

The CaL process has been integrated in cement plants according to two configurations. The first form of integration of the CaL system is the configuration called “Tail End CaL” (FIG. 3), in which the CaL process is positioned downstream of the plant for the production of clinkers and the carbonator treats the fumes exiting from the cement plant (“conventional cement kiln” in the figure, comprising all the components already illustrated in FIG. 1) [4-6]. The type of reactors typically proposed for this configuration are the circulating fluid bed reactors (CFB). The operation of the CaL process under representative conditions for the application in cement plants has been demonstrated in two different installations at 30 kWₜₕ and 200 kWₜₕ [7,8]. A comprehensive study on this configuration, with an extensive sensitivity analysis on the main operating parameters of the system and with a study on the impact of such integration in an existing cement plant, was published by De Lena et al. in [5]. Documents WO 2011/015207 A1, CA2672870 and U.S. Pat. No. 10,434,469 B2 illustrate some examples of the first configuration.

The second configuration known for the use of the CaL process in a cement plant is “Integrated CaL” (FIG. 4), where the carbonator is integrated into the preheating tower of the clinker production line and only treats the exhaust gases exiting from the rotary kiln [9,10].

This configuration is characterized by the following main aspects:
a. the carbonator only treats the gases exiting from the rotary kiln and therefore allows to capture the CO₂ generated by combustion in the rotary kiln itself;
b. the process may include a cooler of the solids used as a CO₂ sorbent (“sorbent cooler”) to indirectly remove the heat generated by the exothermic carbonation reaction and to maintain the carbonator at the desired temperature (this external component is optional in case the carbonator is equipped with internal cooling systems);
c. the sorbent loaded with CO₂ (i.e., rich in CaCO₃) is sent to the calciner, operating in oxygen combustion mode (i.e., combustion in nitrogen-free atmosphere);
d. the calciner receives and decomposes both the sorbent from the carbonator and the preheated raw materials. In other words, the calciner of the CaL process and the calciner of the raw material from the preheater coincide;
e. the calcined solids exiting from the calciner are divided between the rotary kiln, in which they will form the clinker, and the “sorbent cooler-carbonator” group, in which they absorb the CO₂ contained in the combustion gases of the rotary kiln.

This second configuration was recently studied from a technical and economic point of view by De Lena et al. in [11] and demonstrates better energy performances compared to the “Tail-End CaL” configuration. The documents MI2012A00382, MI2012 A003832012 and WO 2013/024340 A1 illustrate some examples of the second configuration.

The use of the “Integrated CaL” configuration, as mentioned, has advantages from an energy point of view compared to the “Tail End CaL” configuration. The main disadvantages of the “Integrated CaL” configuration are linked to:
due to the high integration in the CO₂ capture system in the clinker production phases, there is a possible reduction in the operability of the plant, which might be forced to stop the production of clinkers if there is a need for maintenance on the CO₂ capture system;
the presence of a recirculation of solids between carbonator and calciner (typical in the common CaL systems), which generates an inevitable reduction in the activity of the sorbent used for gas absorption, which decreases as the number of carbonation-calcination cycles increases [12]);
the presence of a recirculation of solids between the carbonator and the calciner, which leads to possible difficulties in controlling the process.

The need is therefore felt to have a process for the production of clinkers integrated with the CO₂ abatement system that has greater operability without negatively affecting the energy performance of the overall system.

US 2018/0028967 discloses a method and the relative system for capturing and separating carbon dioxide from exhaust gas. The system comprises a first calciner, a carbonator, connected to the first calciner, and a second calciner, connected to the carbonator. The CO₂ capture method exploits the calcination reactions of the CO₂-rich sorbent (CaCO₃) in the CO₂-poor sorbent (CaO|) and in CO₂, and the inverse carbonation reaction of the CaO and CO₂ in CaCO₃. The plant comprises a calciner, a carbonator connected to said calciner and to a second calciner to which the rotary kiln is connected. This system provides for a recirculation between the second calciner and the carbonator; therefore, it also features the problems of the Integrated CaL technique associated with the presence of the recirculation between carbonator and calciner, that is the reduction of the activity of the sorbent used for gas absorption, which decreases as the number of carbonation-calcination cycles increases [12]) and the presence of a recirculation of solids between carbonator and calciner, which leads to possible difficulties in controlling the process.

WO2008/151877 A1 discloses a method and the relative plant for the simultaneous production of electricity and cement clinker. The system comprises two separate lines of preheaters, each of which comprises a calciner, a rotary kiln and a clinker cooler, and is characterized in that the combustion air as well as the cement “raw flour”, which are supplied to the calciner, do not contain alkali and chlorides.

### SUMMARY OF THE INVENTION

The Applicants have now found that it is possible to overcome the problems of the state of the art with an assembly comprising:
two calciners and a carbonator arranged between the two calciners, wherein one of the calciners is an integral part of a conventional clinker production system.

This assembly is characterized in that the carbonator is free of recirculation to both said two calciners.

In this way, with the plant comprising the aforesaid assembly, the technical problems of the Integrated CaL system and of the plant disclosed in US 2018/0028967 are overcome.

In fact, the absence of recirculation between the carbonator and the two calciners connected thereto maintains the maximum activity of the sorbent and at the same time there is a greater control over the operating conditions of the process.

Further object of the present invention are the plants comprising said assembly associated with the actual production plant, which differ in the fact that the actual plant is of the conventional type and has been installed before the assembly and is already operational, or it is an ex novo plant in which both the actual plant units and the assembly units have been installed simultaneously with the units belonging to the actual plant for the production of clinkers.

A further object is the clinker production process conducted in the aforesaid plants and which in particular comprises the following steps:
a) A first calcination reaction is conducted in the primary calciner on the raw material stream to give a first stream of CO₂-enriched gas, which is removed and a first calcined material stream comprising CaO. In this step the energy necessary to support the calcination reaction is generated by an oxy-fuel combustion using as oxydizer a mixture formed by high purity O₂ and by part of the gas enriched in recirculated CO₂, in order to avoid dilution with the nitrogen present in the air;
b) The calcined material from step a) is cooled in a sorbent cooler (if the carbonator is not equipped with internal cooling systems);
c) A carbonation reaction is performed between the cooled CaO-enriched calcined material from step b), and the combustion gases from step e) exiting from the rotary kiln in order to remove the CO₂ with consequent enrichment in calcium carbonate of the solid material;
d) A second calcination reaction of the calcium carbonate-enriched material from step c) is conducted in the secondary calciner, producing a second stream of CO₂-enriched gas and a second stream of calcined material comprising CaO. Also in this secondary calciner, the energy necessary to support the calcination reaction is generated by an oxy-fuel combustion using as oxidizer a mixture formed by high purity O₂ and by part of the CO₂ enriched gas exiting from said secondary calciner, in order to avoid dilution with the nitrogen present in the air;
e) The CaO-enriched material is transformed into clinkers in the rotary kiln thanks to the heat provided by the combustion of at least one fuel and air.
f) The final product is cooled in the clinker cooler.

### DESCRIPTION OF THE FIGURES

FIG. 1 represents a block diagram of a conventional plant for the production of clinkers.

FIG. 2 represents a simplified block diagram of a generic Calcium looping CaL process.

FIG. 3 represents a block diagram of the plant for the production of clinkers with the Tail end Calcium looping configuration.

FIG. 4 represents a block diagram of the plant according to the Integrated Calcium looping configuration.

FIG. 5 represents a preferred embodiment of the plant for the production of clinkers with the configuration or assembly according to the present invention in which all the actual operating units used for the production of the clinker are simultaneous with those of the assembly or configuration object of the present invention.

FIG. 6 represents a preferred embodiment for the production of clinkers with the configuration or assembly according to the present invention in which all the actual operating units used for the production of the clinker can be pre-existing and have been identified with the wording “old”.

FIG. 7 represents a further block diagram of a preferred embodiment according to the present invention of the plant for the production of clinkers FIG. 8 illustrates a possible embodiment of the plant object of the present invention.

FIG. 9 represents the absorbent activity diagram of various types of raw flour (RM1, RM2, RM3 and LS pure limestone) as a function of the number of absorption cycles.

### DETAILED DESCRIPTION OF THE INVENTION

For the purposes of the present invention, the definition “comprising” does not exclude the presence of additional units/steps not expressly listed after this definition; on the contrary, the definition “consisting of” or “constituted by”, excludes the presence of additional steps/units in addition to those expressly listed.

For the purposes of the present invention, assembly means the Dual-calciner calcium looping (Du-CaL) configuration, characterized by the presence of two calciners, between which a carbonator is arranged, and of which one of said calciners is an integral part of a conventional clinker production system.

For the purposes of the present invention, primary calciner means the calciner that receives the preheated raw material and that precedes the carbonator, whereas secondary calciner means the calciner that receives the material exiting from the carbonator and prepares it before being introduced into the rotary kiln. According to a preferred solution in the assembly according to the present invention one of said two calciners is the primary calciner (Primary calciner); while the other calciner, arranged downstream of the carbonator (Carbonator) is the secondary calciner (Secondary calciner). In addition, one of the two calciners is an integral part of the conventional clinker production system and can therefore continue to operate in the clinker production process even if the CO₂ capture system which uses the carbonator and the other calciner is disconnected due to malfunctions or maintenance.

The plants containing said assembly or Du-CaL configuration associated with units of plants of conventional type for the production of the clinker and which differ in that the actual units of conventional type dedicated to the production of clinkers existed before or have been installed at the same time as the assembly or Du-CaL configuration are a further object of the invention. It is understood that when the calciner is present in the pre-existing units of the plant for the production of clinkers, this can be adapted in the new configuration to perform the function of both primary calciner and secondary calciner, depending on the specificity of the plant in which the process is integrated.

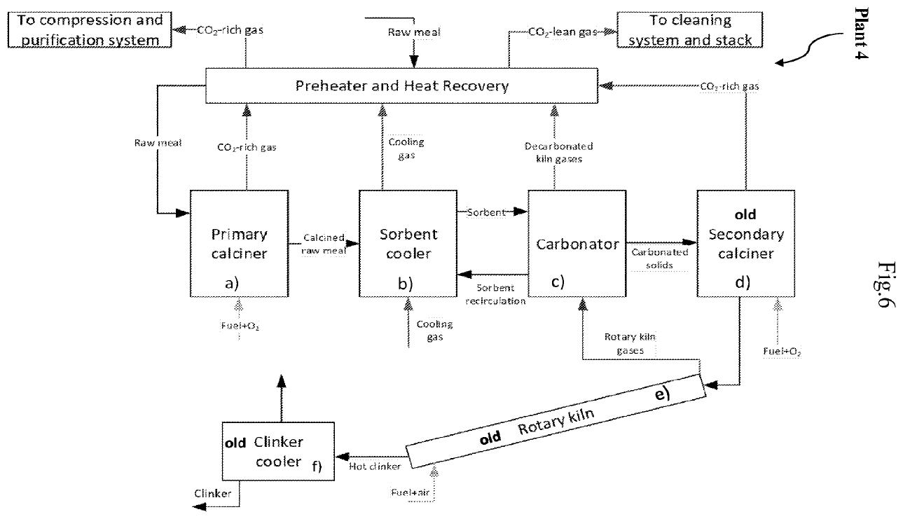

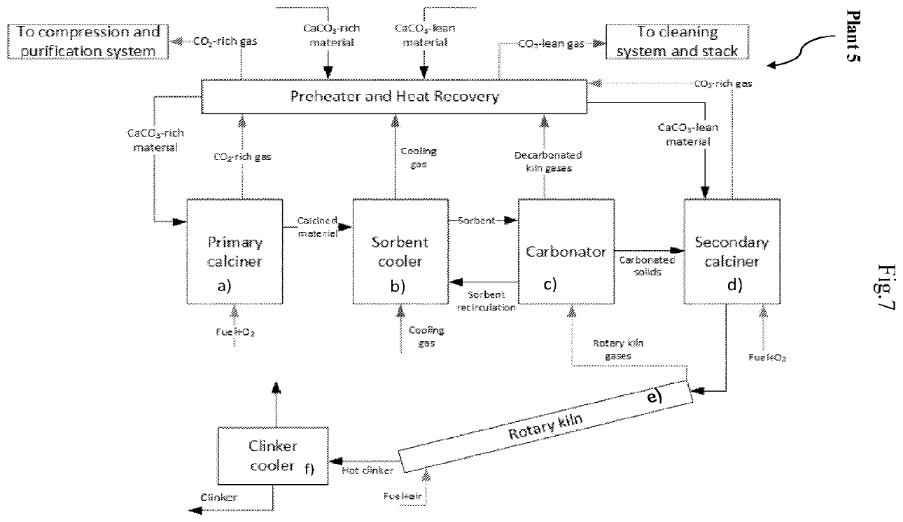

FIGS. 5 and 6 show the preferred embodiments of the invention and in particular of the plants 3 and 4 comprising the assembly according to the present invention comprising the following units: primary calciner indicated in the figures as “Primary calciner” followed by the calcined material cooler and indicated in the figures with the legend “Sorbent cooler” arranged downstream of the primary calciner and finally the carbonator indicated in the figures with the legend “Carbonator” arranged downstream of the Sorbent cooler.

The assembly object of the invention is arranged, with reference to the stream of solid material, upstream of the units of the conventional plant for the production of the clinker. These two plants are distinguished because in the case of plant 4 of FIG. 6 the conventional units existed before the assembly, while in plant 3 of FIG. 5 the assembly is installed simultaneously with the units of the conventional plant. In both cases one of the two calciners forming part of the assembly according to the present invention is also an integral part of the conventional plant intended for the production of clinkers.

According to a preferred solution, the calciner indicated in the figures as “Secondary calciner” is also an integral part of the units of the conventional plant intended for the production of clinkers.

In both figures, downstream of the secondary calciner there is arranged the rotary kiln or “Rotary kiln” as shown in the figures followed in turn by the clinker cooler indicated in the figures as “Clinker cooler”.

Preferably, in both types of plants of FIGS. 5 and 6 the assembly units: primary calciner, possible calcined material cooler and carbonator can be easily disconnected in case of malfunction and maintenance, and reconnected after repair and after maintenance.

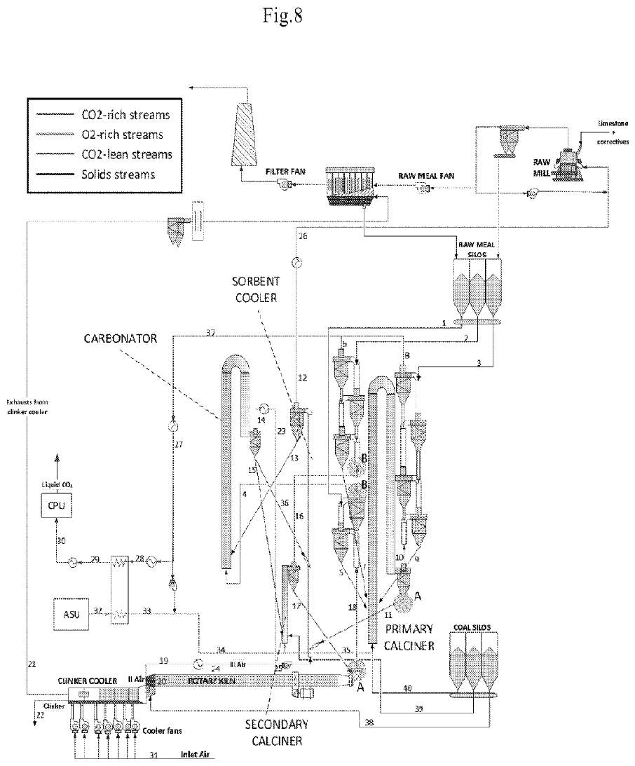

FIG. 7 also provides for the possibility of adding raw flour poor in calcium carbonate directly to the secondary calciner.

The plant can be fed with two separate flour mixtures, the first rich in CaCO₃ (>65% by mass) and the second poor in CaCO₃ (<65% by mass). The CaCO₃-rich flour, after being preheated, is fed to the primary calciner (a) and is used as a sorbent for the removal of CO₂ in the carbonator (c). As far as the CaCO₃-poor material is concerned, it is preheated and fed to the secondary calciner (d) together with the material exiting from the carbonator (c). The overall mixture exiting from the secondary calciner is fed to the rotary kiln (e) to complete the clinker production steps.

With this type of configuration, it is also easier to operate the plant especially in cases where the carbonator and/or primary calciner are disconnected due to malfunctions or maintenance. In this case the process of the invention would be reduced to steps d), e), f) only.

Preferably in all the three plants according to the present invention represented in FIGS. 5-7 upstream of the calciner, they are equipped with at least one preheater and a heat recovery system indicated in the figure with the legend “Preheater and Heat Recovery”.

For example, they contain three preheaters arranged in parallel in several steps and, according to a particularly preferred solution such as the one shown in FIG. 8 these three are respectively at 3, 4 and 2 stages.

All three of the aforesaid plants object of the present invention upstream of the preheater are equipped with one or more grinders of the starting raw mineral indicated in FIG. 8 with the wording “Raw mill”.

Preferably in the process of the invention, the calcination steps operate with output temperatures between 850° C. and 950° C. and employ as a heat source the combustion reaction of a mixture of fuel and oxygen with low nitrogen content and other gases other than CO₂ and H₂O, to easily recover the CO₂ exiting from said calciners.

In the cooler in step b) of the process according to the present invention the calcined material is preferably cooled to a temperature between 55° and 650° C.

Preferably in the process according to the present invention in step c) of carbonation the combustion gases rich in CO₂ and N₂, deriving from the processes of combustion in air in the rotary kiln, are employed. The output temperature from this step is preferably between 65° and 750° C.

If reference is made in particular to FIGS. 5-7, the raw material is preheated in the preheating unit (preheater) and sent to the primary calciner. The calcined solids rich in CaO at about 850-950° C. are sent to the sorbent cooler, where they are cooled up to a temperature such as to ensure a gas-solid mixing temperature at the inlet to the carbonator preferably in the range 550-650° C. The sorbent, i.e. the calcined material in the primary calciner and cooled, is then sent to the carbonator, where it captures the CO₂ generated in the rotary kiln by entering into direct contact with the combustion gases coming from said rotary kiln. The CO₂-poor gases exiting from the carbonator are sent to the chimney after cooling with heat recovery. The CaCO₃-rich solids exiting from the carbonator at 650-750° C. are partly sent to the sorbent cooler and then returned to the carbonator to control the operating temperature of the latter. The remaining part is sent to the secondary calciner which has the function of achieving a high calcination degree of the solids, preferably between 85 and 95%, which can then be introduced into the rotary kiln. Both calciners operate with a combustion process performed in an atmosphere rich in O₂ and poor in nitrogen, which makes it possible to generate gases with a high concentration of CO₂, to be sent for example to permanent storage after compression and purification.

In both plants 3 and 4 shown in FIGS. 5 and 6, the gases exiting from the various reactors enter a system for preheating the raw meal and of heat exchangers, to recover the heat generated in the various reactions and increase the energy efficiency of the overall system.

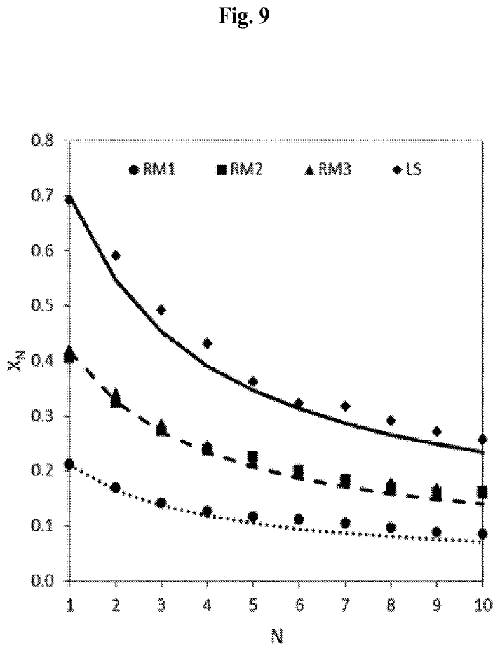

The main difference compared to the classic “Integrated CaL” configuration is that the solids exiting from the carbonator do not return to the first calciner, but do not return either to the second calciner as disclosed in US 2018/0028967. Thus, the configuration object of the present invention is also defined as a single passage (“once-through”), without recirculations between the carbonator and the two calciners. Therefore, in the “Du-CaL” configuration, the raw material does not undergo multiple calcination-carbonation cycles and the sorbent used in the carbonator derives from a single calcination process performed in the primary calciner. This allows for better performances in terms of CO₂ removal efficiency, because there is no deactivation of the material caused by repeated calcination-carbonation cycles as clearly reported in the graph of FIG. 9 taken from Alonso M, Criado Y. Fernàndez J. R., Abanades C.: CO₂ Carrying Capacities of Cement Raw Meals in Calcium Looping Systems, Energy & Fuels 2017, 31, 13955-13962) which shows the decrease in Calcium (XN) conversion as the number of cycles (N) for limestone (LS) and for three different raw meals (RM) increases. The proposed DuCaL process, with double calciner and no sorbent recirculation between carbonator and calciner, allows the sorbent to work with the properties of the N=1 cycle, thus exploiting its maximum CO₂ capture capacity.

We can therefore conclude that with this type of assembly, or Du-CaL configuration, the following results are obtained:
1) no recirculations are performed between the carbonator and the calciner, a feature that improves the controllability of the process.
2) The calcined material used for capturing CO₂ undergoes only one calcination process (in the first calciner). The absence of repeated calcination-carbonation cycles allows to improve the ability of the obtained CaO to react with the CO₂| forming CaCO₃ and therefore to increase the performances of the process. This happens for the following reasons: (i) it is well known that repeated calcination-carbonation cycles worsen the properties of CaO as a CO₂ sorbent: the sorbent resulting from a single calcination thus possesses the maximum capacity to absorb CO₂ in the carbonator; (ii) the primary calciner can be controlled such as to work at moderate temperature and/or with low residence time, so as to minimize parasitic reactions (in particular the reaction between CaO and SiO₂ which leads to the formation of Calcium-Silicates) and produce a high-performance sorbent (the lower the calcination temperature and the residence time, the better the performance of CaO as sorbent), while the secondary calciner can operate at a higher temperature to obtain a high calcination degree, thus producing a better material for firing in the rotary kiln. In other words, the operating conditions of the two calciners can be modulated so as to obtain the best possible properties of the calcined material: (i) the primary calciner to produce the optimum sorbent; (ii) the secondary calciner to produce highly calcined material for the following clinker production.
3) The Du-CaL configuration allows an easier retrofit of existing plants, in fact, as mentioned above, it can be installed in plants of the conventional and pre-existing type for the production of clinkers and a greater reliability for the production of clinkers: the new units to be installed (additional calciner, possible calcined material cooler and carbonator) can be easily disconnected in case of malfunction or maintenance need from the existing cement plant, and reconnected after repair of the malfunction or at the end of maintenance. As shown by way of example in FIG. 8, to restore the operation of the plant for the production of clinkers without CaL system, during the repair or maintenance phase it is possible to divert the streams by connecting: (i) the outlet of the solids from the primary calciner and the rotary kiln (section A-A) and (ii) the outlet of the gases from the lower part of the preheater, with the upper part (section B-B).

FIG. 8 shows a possible application example for the Du-CaL system. In this case, the calciner of the reference plant is the primary calciner of said Du-CaL system, in which the (preheated) raw meal is fed and calcined. Specifically, in this particular application example (FIG. 7), the raw meal is divided into three different streams (streams #1, #2, #3) and each of them is preheated in a different cyclone preheater. One part (#1) is preheated by exploiting the combustion gases from the rotary kiln (#18) up to 800° C., another part (#2) is preheated up to 820° C. by exploiting the CO₂-enriched gases from the secondary calciner (#16) and the remaining part (#3) is preheated by exploiting the gases exiting from the primary calciner (#10). The whole preheated raw meal (streams #5, #7, #9) is sent to the primary calciner where the calcium carbonate is decomposed into CaO and CO₂. The calcined material (#11) is sent to the sorbent cooler where it is cooled to ensure an input temperature of the carbonator of 600° C. The cooling medium is a mixture of CO₂-poor gases from the carbonator itself (#14) and of tertiary air from the clinker cooler (#19). Both these streams, before entering the sorbent cooler, are cooled in order to meet the specifications of the input temperature of the carbonator. Upon exiting from the sorbent cooler, the CO₂-depleted gases (#12) are cooled recovering some of the heat and then used to dry the raw meal in the mill. The combustion gases exiting from the rotary kiln, after having preheated part of the raw meal, are sent to the carbonator (#4), where the CO₂ reacts with the CaO generating CaCO₃. At the outlet, the CO₂-depleted gases, as mentioned above, are sent in the sorbent cooler. Also a portion of the solids exiting from the carbonator (#36) is sent to the sorbent cooler to increase the residence time of the particles and the overall stock of the solids in the reactor, thereby improving the conversion of the sorbent. The remainder of the solids (#15) is sent to the secondary calciner, where the calcium carbonate is decomposed into CaO and CO₂. The calcined solids (#17) are finally sent to the rotary kiln, where the clinker firing steps take place. The high-temperature clinker exiting from the rotary kiln is then cooled in the clinker cooler. The CO₂-rich gases from the two calciners (#6, #8) are used for preheating the raw meal. A part of them is recirculated to moderate the flame temperature in the reactors. The remaining part (#28) is first used to preheat the high purity oxygen used in the system (#32), and then sent to the CPU (#30).

The presence of the two calciners allows to ensure an adequate calcination degree of the solids entering the rotary kiln and, at the same time, to generate an optimal calcined material for the performance of the carbonator.

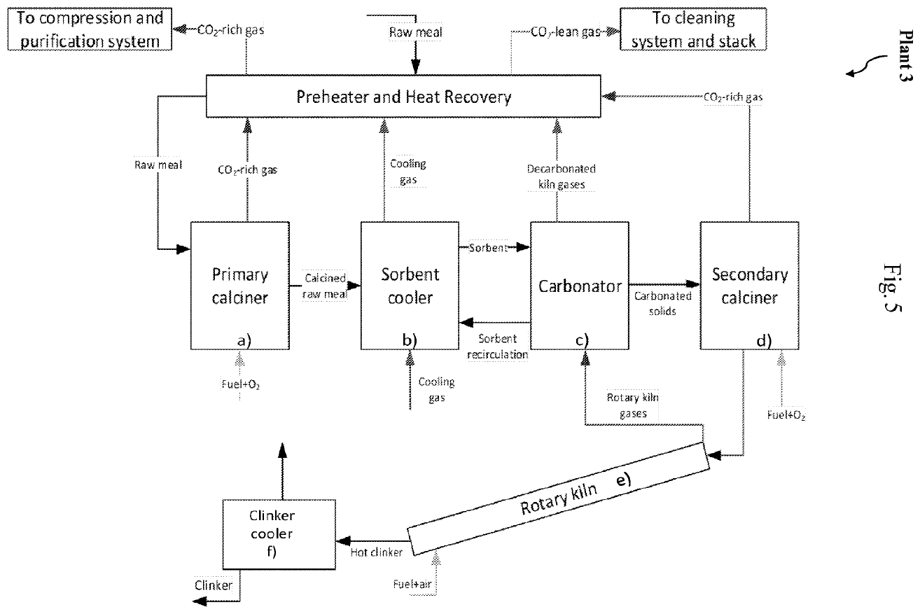

Below are the results of the mass and energy balances obtained from process simulations of a possible example of a Du-CaL system (FIG. 7), compared to an “Integrated CaL” system (FIG. 4). Since the sorbent would be more active in the Du-CaL case thanks to the absence of repeated carbonation and calcination cycles, for the simulations and the analysis of the performance of the system a maximum possible conversion of the sorbent in the carbonator equal to 60% was assumed, to be compared with the maximum conversion of 40% assumed for the “Integrated CaL” case, in accordance with De Lena et al. in [11]. It should be pointed out that the values assumed for the maximum conversion of the sorbent have a degree of uncertainty linked to the nature of the material and to the characteristics of the calciner, which can only be confirmed by experimental results under conditions representative of industrial plants, currently not available.

It has also been imposed, in this particular example, that the solids exiting from the primary calciner (#11) have a temperature of 920° C., a calcination degree equal to 92.5% and a composition completely similar to that presented in [11]. The secondary calciner ensures that the solids entering the rotary kiln have a composition typical of those entering the rotary kiln of a modern cement plant. This means that the operating conditions of the rotary kiln and of the clinker cooler remain similar to those of a modern cement plant with a clinker production of about 2500-3000 t/day.

The table with the thermodynamic properties and the composition of the various streams present in FIG. 8 are shown in table 1 (for details of the properties of the streams of the “Integrated CaL” case, refer to [11]).

TABLE 1
Stream properties for the Du-CaL case presented in FIG. 7

| | | Mass | Temp | P | Ar | CO₂ | H₂O | N₂ | O₂ | Moi | C4AF |
|---|---|---|---|---|---|---|---|---|---|---|---|
| | | kg/s | ° C. | bar | % vol | % vol | % vol | % vol | % vol | % wt | % wt. |
| 1 | (s) | 15.09 | 60.0 | 1.01 | — | — | — | — | — | 0.29 | 0.00 |
| 2 | (s) | 6.98 | 60.0 | 1.01 | — | — | — | — | — | 0.29 | 0.00 |
| 3 | (s) | 30.18 | 60.0 | 1.01 | — | — | — | — | — | 0.29 | 0.00 |
| 4 | (g) | 17.68 | 508.0 | 1.01 | 0.85 | 17.97 | 6.17 | 71.31 | 3.70 | — | — |
| 4 | (s) | 0.86 | 508.0 | 1.01 | — | — | — | — | — | 0.00 | 0.33 |
| 5 | (s) | 17.12 | 820.1 | 1.01 | — | — | — | — | — | 0.00 | 1.64 |
| 6 | (g) | 11.67 | 512.1 | 1.01 | 1.34 | 73.57 | 11.76 | 7.26 | 6.06 | — | — |
| 6 | (s) | 0.41 | 512.1 | 1.01 | — | — | — | — | — | 0.00 | 0.00 |
| 7 | (s) | 18.92 | 860.0 | 1.01 | — | — | — | — | — | 0.00 | 0.50 |
| 8 | (g) | 59.28 | 560.6 | 1.01 | 1.18 | 79.42 | 10.62 | 3.57 | 5.20 | — | — |
| 8 | (s) | 1.72 | 560.6 | 1.01 | — | — | — | — | — | 0.00 | 0.00 |
| 9 | (s) | 44.06 | 869.2 | 1.01 | — | — | — | — | — | 0.00 | 0.27 |
| 10 | (g) | 39.19 | 360.2 | 1.11 | 1.69 | 56.10 | 7.73 | 3.55 | 30.00 | — | — |
| 10 | (s) | 15.69 | 920.0 | 1.01 | — | — | — | — | — | 0.00 | 0.78 |
| 11 | (s) | 48.62 | 920.0 | 1.01 | — | — | — | — | — | 0.00 | 0.76 |
| 12 | (g) | 40.19 | 618.0 | 1.01 | 0.95 | 1.48 | 3.22 | 79.42 | 14.94 | — | — |
| 12 | (s) | 0.00 | 618.0 | 1.01 | — | — | — | — | — | 0.00 | 0.00 |
| 13 | (s) | 106.74 | 618.0 | 1.01 | — | — | — | — | — | 0.00 | 0.86 |
| 14 | (g) | 14.00 | 706.4 | 1.01 | 0.99 | 4.14 | 7.21 | 83.34 | 4.32 | 0.00 | 0.00 |
| 14 | (s) | 5.56 | 706.4 | 1.01 | — | — | — | — | — | 0.00 | 0.84 |
| 15 | (s) | 53.91 | 706.4 | 1.01 | — | — | — | — | — | 0.00 | 0.83 |
| 16 | (g) | 11.05 | 920.0 | 1.01 | 1.38 | 79.33 | 12.20 | 2.10 | 5.00 | — | — |
| 16 | (s) | 12.37 | 920.0 | 1.01 | — | — | — | — | — | 0.00 | 0.76 |
| 17 | (s) | 38.32 | 920.0 | 1.01 | — | — | — | — | — | 0.00 | 0.77 |
| 18 | (g) | 17.24 | 1078.5 | 1.01 | 0.85 | 18.49 | 5.89 | 71.48 | 3.30 | — | — |
| 18 | (s) | 2.93 | 1078.5 | 1.01 | — | — | — | — | — | 0.00 | 9.66 |
| 19 | (g) | 26.19 | 1049.8 | 1.01 | 0.92 | 0.03 | 1.03 | 77.28 | 20.73 | — | — |
| 19 | (s) | 0.76 | 1049.8 | 1.01 | — | — | — | — | — | 0.00 | 9.86 |
| 20 | (g) | 14.51 | 915.1 | 1.01 | 0.92 | 0.03 | 1.03 | 77.28 | 20.73 | — | — |
| 21 | (g) | 39.40 | 299.0 | 1.01 | 0.92 | 0.03 | 1.03 | 77.28 | 20.73 | — | — |
| 21 | (s) | 1.18 | 299.0 | 1.01 | — | — | — | — | — | 0.00 | 9.60 |
| 22 | (s) | 32.60 | 114.9 | 1.01 | — | — | — | — | — | 0.00 | 9.66 |
| 23 | (g) | 14.00 | 212.9 | 0.97 | 0.99 | 4.14 | 7.21 | 83.34 | 4.32 | — | — |
| 23 | (s) | 5.56 | 212.9 | 0.97 | — | — | — | — | — | 0.00 | 0.84 |
| 24 | (g) | 26.19 | 212.9 | 1.01 | 0.92 | 0.03 | 1.03 | 77.28 | 20.73 | — | — |
| 24 | (s) | 0.76 | 212.9 | 1.01 | — | — | — | — | — | 0.00 | 9.86 |
| 25 | (g) | 40.19 | 212.9 | 0.97 | 0.95 | 1.48 | 3.21 | 79.42 | 14.94 | — | — |
| 25 | (s) | 6.32 | 212.9 | 0.97 | — | — | — | — | — | 0.00 | 1.93 |
| 26 | (g) | 40.19 | 434.2 | 1.01 | 0.95 | 1.48 | 3.22 | 79.42 | 14.94 | — | — |
| 26 | (s) | 0.00 | 434.2 | 1.01 | — | — | — | — | — | 0.00 | 0.00 |
| 27 | (g) | 70.95 | 400.0 | 1.01 | 1.21 | 78.44 | 10.81 | 4.19 | 5.35 | — | — |
| 27 | (s) | 2.13 | 400.0 | 1.01 | — | — | — | — | — | 0.00 | 0.00 |
| 28 | (g) | 38.13 | 320.0 | 1.01 | 1.21 | 78.44 | 10.81 | 4.19 | 5.35 | — | — |
| 28 | (s) | 1.14 | 320.0 | 1.01 | — | — | — | — | — | 0.00 | 0.00 |
| 29 | (g) | 38.13 | 285.5 | 1.01 | 1.21 | 78.44 | 10.81 | 4.19 | 5.35 | — | — |
| 29 | (s) | 1.14 | 285.5 | 1.01 | — | — | — | — | — | 0.00 | 0.00 |
| 30 | (g) | 38.13 | 60.0 | 1.01 | 1.21 | 78.44 | 10.81 | 4.19 | 5.35 | — | — |
| 30 | (s) | 1.14 | 60.0 | 1.01 | — | — | — | — | — | 0.00 | 0.00 |
| 31 | (g) | 77.01 | 15.0 | 1.01 | 0.92 | 0.03 | 1.03 | 77.28 | 20.73 | — | — |
| 32 | (g) | 2.93 | 15.0 | 1.11 | 3.00 | 0.00 | 0.00 | 2.00 | 95.00 | — | — |
| 32b | (g) | 9.09 | 15.0 | 1.11 | 3.00 | 0.00 | 0.00 | 2.00 | 95.00 | — | — |
| 33 | (g) | 2.93 | 150.0 | 1.11 | 3.00 | 0.00 | 0.00 | 2.00 | 95.00 | — | — |
| 33b | (g) | 9.09 | 150.0 | 1.11 | 3.00 | 0.00 | 0.00 | 2.00 | 95.00 | — | — |
| 34 | (g) | 6.53 | 308.1 | 1.11 | 2.11 | 39.09 | 5.39 | 3.09 | 50.32 | — | — |
| 34 | (s) | 0.11 | 308.1 | 1.11 | — | — | — | — | — | 0.00 | 0.00 |
| 35 | (g) | 38.31 | 360.2 | 1.11 | 1.71 | 56.62 | 7.80 | 3.58 | 30.28 | — | — |
| 35 | (s) | 0.88 | 360.2 | 1.11 | — | — | — | — | — | 0.00 | 0.00 |
| 36 | (s) | 51.80 | 706.4 | 1.01 | — | — | — | — | — | 0.00 | 0.83 |

| | | | | | |
|---|---|---|---|---|---|
| 38 | (f) | 1.38 | 60.0 | 1.01 | 69%, 4% H, 0.5% S, 0.48 N, 9% O, 16.5% ash; LHV = 27.15 MJ/kg |
| 39 | (f) | 1.19 | 60.0 | 1.01 | 69%, 4% H, 0.5% S, 0.48 N, 9% O, 16.5% ash; LHV = 27.15 MJ/kg |
| 40 | (f) | 3.62 | 60.0 | 1.01 | 69%, 4% H, 0.5% S, 0.48 N, 9% O, 16.5% ash; LHV = 27.15 MJ/kg |

| | | C3S | C3A | C2S | CaO | CaCO₃ | SiO₂ | Al₂O₃ | Fe₂O₃ | MgCO₃ | MgO | CaSO₄ |
|---|---|---|---|---|---|---|---|---|---|---|---|---|
| | | % wt. | % wt. | % wt. | % wt. | % wt. | % wt. | % wt. | % wt. | % wt. | % wt. | % wt. |
| 1 | (s) | 0.00 | 0.00 | 0.00 | 0.00 | 79.43 | 13.38 | 3.34 | 2.02 | 1.54 | 0.00 | 0.00 |
| 2 | (s) | 0.00 | 0.00 | 0.00 | 0.00 | 79.43 | 13.38 | 3.34 | 2.02 | 1.54 | 0.00 | 0.00 |
| 3 | (s) | 0.00 | 0.00 | 0.00 | 0.00 | 79.43 | 13.38 | 3.34 | 2.02 | 1.54 | 0.00 | 0.00 |
| 4 | (g) | — | — | — | — | — | — | — | — | — | — | — |
| 4 | (s) | 1.72 | 0.37 | 0.35 | 0.04 | 77.37 | 13.02 | 3.29 | 1.97 | 1.50 | 0.03 | 0.00 |
| 5 | (s) | 10.80 | 1.81 | 2.35 | 0.13 | 66.13 | 11.14 | 2.78 | 1.68 | 1.28 | 0.20 | 0.07 |
| 6 | (g) | — | — | — | — | — | — | — | — | — | — | — |
| 6 | (s) | 0.17 | 0.00 | 0.51 | 1.88 | 76.99 | 13.49 | 3.41 | 2.02 | 1.50 | 0.03 | 0.00 |
| 7 | (s) | 2.90 | 0.61 | 9.68 | 31.76 | 31.86 | 14.11 | 4.56 | 2.55 | 0.53 | 0.73 | 0.20 |
| 8 | (g) | — | — | — | — | — | — | — | — | — | — | — |
| 8 | (s) | 0.00 | 0.00 | 0.15 | 0.59 | 78.81 | 13.45 | 3.37 | 2.09 | 1.54 | 0.00 | 0.00 |
| 9 | (s) | 1.59 | 0.34 | 5.43 | 17.86 | 52.94 | 13.77 | 3.99 | 2.32 | 0.99 | 0.40 | 0.09 |
| 10 | (g) | — | — | — | — | — | — | — | — | — | — | — |
| 10 | (s) | 4.48 | 0.95 | 15.27 | 50.20 | 4.52 | 14.41 | 5.15 | 2.85 | 0.00 | 1.13 | 0.26 |
| 11 | (s) | 4.48 | 0.95 | 15.28 | 50.21 | 4.52 | 14.42 | 5.14 | 2.85 | 0.00 | 1.13 | 0.26 |
| 12 | (g) | — | — | — | — | — | — | — | — | — | — | — |
| 12 | (s) | 0.00 | 0.00 | 0.00 | 100.00 | 0.00 | 0.00 | 0.00 | 0.00 | 0.00 | 0.00 | 0.00 |
| 13 | (s) | 5.16 | 1.05 | 14.57 | 42.53 | 13.26 | 13.66 | 4.86 | 2.70 | 0.00 | 1.09 | 0.25 |
| 14 | (g) | 0.00 | 0.00 | 0.00 | 0.00 | 0.00 | 0.00 | 0.00 | 0.00 | 0.00 | 0.00 | 0.00 |
| 14 | (s) | 4.95 | 1.02 | 13.98 | 36.57 | 20.85 | 13.20 | 4.69 | 2.60 | 0.00 | 1.05 | 0.24 |
| 15 | (s) | 4.96 | 1.01 | 13.98 | 36.57 | 20.86 | 13.21 | 4.69 | 2.60 | 0.00 | 1.05 | 0.24 |
| 16 | (g) | — | — | — | — | — | — | — | — | — | — | — |
| 16 | (s) | 4.44 | 0.93 | 14.82 | 48.65 | 6.47 | 14.48 | 5.20 | 2.83 | 0.00 | 1.13 | 0.30 |
| 17 | (s) | 4.44 | 0.93 | 14.82 | 48.64 | 6.46 | 14.48 | 5.20 | 2.83 | 0.00 | 1.13 | 0.30 |
| 18 | (g) | — | — | — | — | — | — | — | — | — | — | — |
| 18 | (s) | 63.58 | 10.63 | 13.83 | 0.76 | 0.00 | 0.00 | 0.00 | 0.00 | 0.00 | 1.16 | 0.38 |
| 19 | (g) | — | — | — | — | — | — | — | — | — | — | — |
| 19 | (s) | 63.50 | 10.64 | 13.78 | 0.74 | 0.00 | 0.00 | 0.00 | 0.00 | 0.00 | 1.15 | 0.33 |
| 20 | (g) | — | — | — | — | — | — | — | — | — | — | — |
| 21 | (g) | — | — | — | — | — | — | — | — | — | — | — |
| 21 | (s) | 63.66 | 10.67 | 13.81 | 0.78 | 0.00 | 0.00 | 0.00 | 0.00 | 0.00 | 1.17 | 0.32 |
| 22 | (s) | 63.56 | 10.63 | 13.84 | 0.77 | 0.00 | 0.00 | 0.00 | 0.00 | 0.00 | 1.16 | 0.39 |
| 23 | (g) | — | — | — | — | — | — | — | — | — | — | — |
| 23 | (s) | 4.95 | 1.02 | 13.98 | 36.57 | 20.85 | 13.20 | 4.69 | 2.60 | 0.00 | 1.05 | 0.24 |
| 24 | (g) | — | — | — | — | — | — | — | — | — | — | — |
| 24 | (s) | 63.50 | 10.64 | 13.78 | 0.74 | 0.00 | 0.00 | 0.00 | 0.00 | 0.00 | 1.15 | 0.33 |
| 25 | (g) | — | — | — | — | — | — | — | — | — | — | — |
| 25 | (s) | 12.01 | 2.15 | 13.97 | 32.27 | 18.34 | 11.61 | 4.12 | 2.28 | 0.00 | 1.06 | 0.25 |
| 26 | (g) | — | — | — | — | — | — | — | — | — | — | — |
| 26 | (s) | 0.00 | 0.00 | 0.00 | 100.00 | 0.00 | 0.00 | 0.00 | 0.00 | 0.00 | 0.00 | 0.00 |
| 27 | (g) | — | — | — | — | — | — | — | — | — | — | — |
| 27 | (s) | 0.00 | 0.00 | 0.29 | 0.81 | 78.53 | 13.44 | 3.37 | 2.03 | 1.50 | 0.03 | 0.00 |
| 28 | (g) | — | — | — | — | — | — | — | — | — | — | — |
| 28 | (s) | 0.00 | 0.00 | 0.29 | 0.81 | 78.53 | 13.44 | 3.37 | 2.03 | 1.50 | 0.03 | 0.00 |
| 29 | (g) | — | — | — | — | — | — | — | — | — | — | — |
| 29 | (s) | 0.00 | 0.00 | 0.00 | 0.29 | 0.81 | 78.53 | 13.44 | 3.37 | 2.03 | 1.50 | 0.03 |
| 30 | (g) | — | — | — | — | — | — | — | — | — | — | — |
| 30 | (s) | 0.00 | 0.00 | 0.29 | 0.81 | 78.53 | 13.44 | 3.37 | 2.03 | 1.50 | 0.03 | 0.00 |
| 31 | (g) | — | — | — | — | — | — | — | — | — | — | — |
| 32 | (g) | — | — | — | — | — | — | — | — | — | — | — |
| 32b | (g) | — | — | — | — | — | — | — | — | — | — | — |
| 33 | (g) | — | — | — | — | — | — | — | — | — | — | — |
| 33b | (g) | — | — | — | — | — | — | — | — | — | — | — |
| 34 | (g) | — | — | — | — | — | — | — | — | — | — | — |
| 34 | (s) | 0.00 | 0.00 | 0.29 | 0.81 | 78.53 | 13.44 | 3.37 | 2.03 | 1.50 | 0.03 | 0.00 |
| 35 | (g) | — | — | — | — | — | — | — | — | — | — | — |
| 35 | (s) | 0.00 | 0.00 | 0.29 | 0.81 | 78.53 | 13.44 | 3.37 | 2.03 | 1.50 | 0.03 | 0.00 |
| 36 | (s) | 4.96 | 1.01 | 13.98 | 36.57 | 20.86 | 13.21 | 4.69 | 2.60 | 0.00 | 1.05 | 0.24 |

| | | |
|---|---|---|
| 38 | (f) | 69%, 4% H, 0.5% S, 0.48 N, 9% O, 16.5% ash; LHV = 27.15 MJ/kg |
| 39 | (f) | 69%, 4% H, 0.5% S, 0.48 N, 9% O, 16.5% ash; LHV = 27.15 MJ/kg |
| 40 | (f) | 69%, 4% H, 0.5% S, 0.48 N, 9% O, 16.5% ash; LHV = 27.15 MJ/kg |

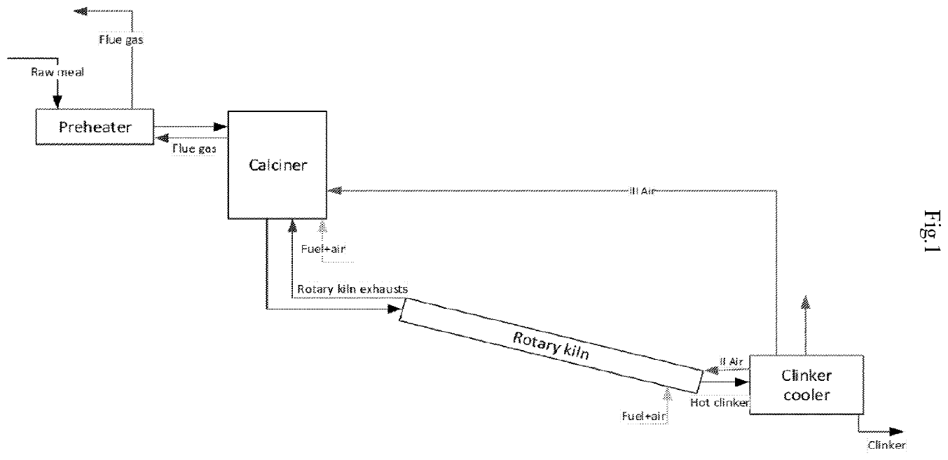

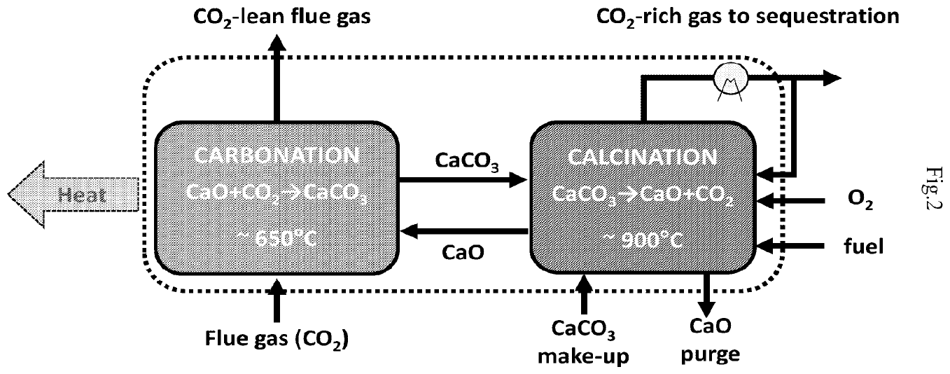

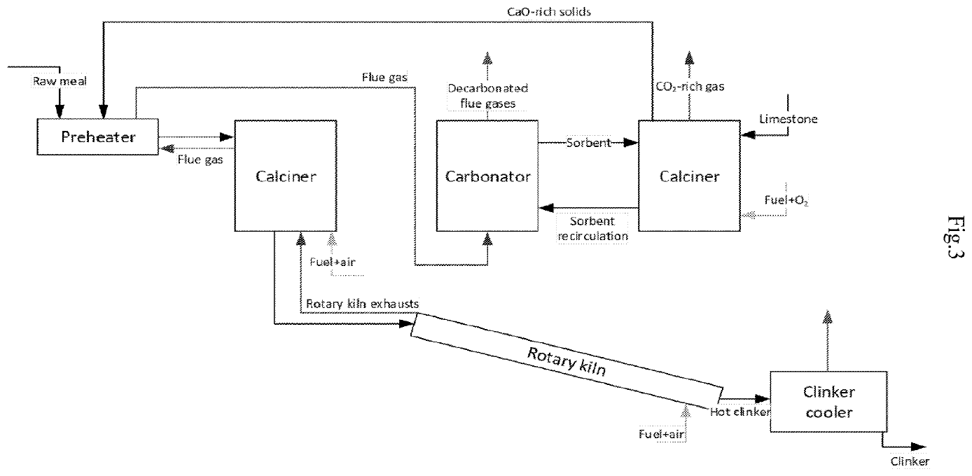

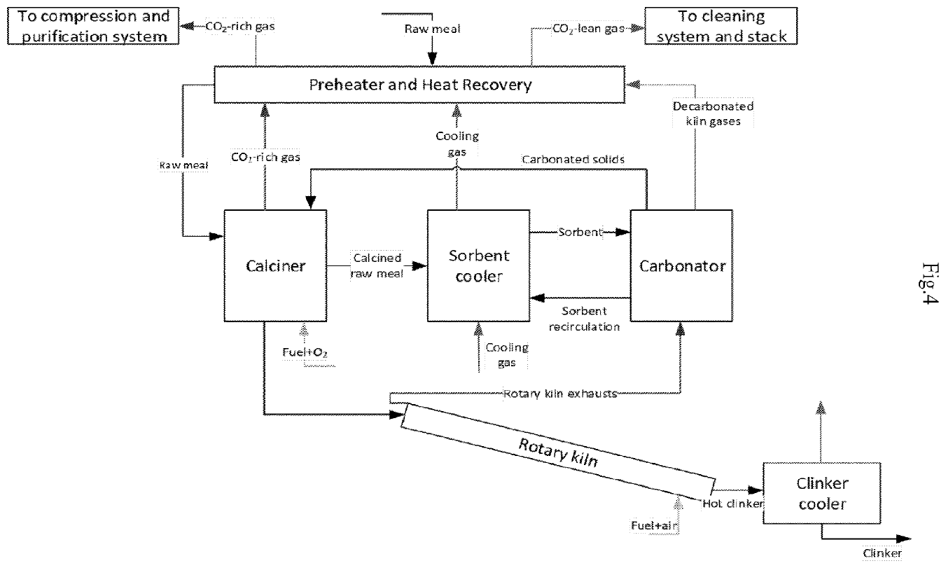

Table 2 shows the results of the material and energy balance of the particular Du-CaL case shown in FIG. 7 (central column), compared with the results present in [11] for the Integrated CaL configuration of FIG. 4 (right column) and for the reference cement plant without CO₂ capture of FIG. 1 (left column).

TABLE 2
Material and energy balances for an example case of the Du-CaL and Integrated CaL
configuration [11]. The quantities shown refer to the clinker unit (clk) produced.

| | Reference | | Integrated |
|---|---|---|---|
| | cement plant | Du-CaL | CaL |
| Maximum sorbent conversion, % | — | 60% | 40% |
| Total fuel consumption, MJ_{LHV}/kg_{clk} | 3.24 | 5.16 | 5.44 |
| Fuel consumption in the rotary kiln, MJ_{LHV}/kg_{clk} | 1.23 | 1.15 | 1.15 |
| Fuel consumption in the primary calciner, MJ_{LHV}/kg_{clk} | 2.01 | 3.02 | 4.29 |
| Fuel consumption in the secondary calciner, | — | 0.99 | — |
| MJ_{LHV}/kg_{clk} | | | |
| Total CO₂ emissions, kg_{CO2}/t_{clk} | 865.2 | 44.9 | 44.2 |
| CO₂ emissions in the fumes, kg_{CO2}/t_{clk} | 865.2 | 28.0 | 25.7 |
| CO₂ emissions from the CPU, kg_{CO2}/t_{clk} | — | 16.8 | 18.5 |
| Reduction of total CO₂ emissions, % | — | 94.6% | 94.9% |

Power balance

| | | | |
|---|---|---|---|
| Net electricity produced in the steam cycle, kWh_{and}/t_{clk} | — | 158.7 | 179.5 |
| Electrical consumptions ASU, kWhe/t_{clk} | — | 78.7 | 84.9 |
| Electrical consumptions of fans (CaL system), kWhe/t_{clk} | — | 9.6 | 10.3 |
| Electrical consumptions CPU, kWhe/t_{clk} | — | 114.2 | 117.3 |
| Electrical consumptions of cooling system, kWh_{and}/t_{clk} | — | 5.0 | 5.0 |
| Electrical consumptions of other auxiliaries, kWhand/t_{clk} | 131.6 | 137.5 | 117.3 |
| Net electricity consumptions, kWh_{and}/t_{clk} | 131.6 | 186.3 | 171.0 |

The Du-CaL configuration allows to achieve a reduction of the CO₂ emissions of the cement plant by about 95%, a value similar to that obtained in the Integrated CaL case, but with a fuel saving in the system of about 5.2% (5.16 MJ_{LHV}/kgₑₗₖ against 5.44 MJ_{LHV}/kgₑₗₖ). This is mainly due to the lack of solid material recirculation between carbonator and calciner in the Du-CaL configuration and to the increased activity of the sorbent used. In fact, avoiding recirculation between carbonator and calciner also avoids the energy expenditure due to heating from about 700° C. (carbonator output temperature) to about 920° C. (calciner output temperature) of the aggregates accumulated in the system, while the presence of more active material, allows to achieve high CO₂ removal efficiencies with a lower recirculation of solids in the carbonator. Since there is less fuel consumption in the Du-CaL system, the advantage of smaller dimensions being required for very expensive components common to the two plants, such as the air separation unit (ASU) and the CO₂ compression and purification unit (CPU), compared to the Integrated CaL case, is also achieved. The lower fuel consumption in the Du-CaL case is also associated with a smaller steam cycle which therefore produces a lower electrical power compared to the Integrated CaL case.

### BIBLIOGRAPHY

[1] IEA, Cement Technology Roadmap 2009: Carbon emissions reductions up to 2050, 2009. doi:10.1787/9789264088061;
[2] B. Arias, M. E. Diego, J. C. Abanades, M. Lorenzo, L. Diaz, D. Martinez, J. Alvarez, A. Sánchez-Biezma, Demonstration of steady state CO₂ capture in a 1.7 MWth calcium looping pilot, Int. J. Greenh. Gas Control. 18 (2013) 237-245. doi:10.1016/j.ijggc.2013.07.014;
[3] J. Kremer, A. Galloy, J. Strohle, B. Epple, Continuous CO2 Capture in a 1-MWₜₕ Carbonate Looping Pilot Plant, Chem. Eng. Technol. 36 (2013) 1518-1524. doi:10.1002/ceat.201300084;
[4] K. Atsonios, P. Grammelis, S. K. Antiohos, N. Nikolopoulos, E. Kakaras, Integration of calcium looping technology in existing cement plant for CO₂capture: Process modeling and technical considerations, Fuel. 153 (2015) 210-223. doi:10.1016/j.fuel.2015.02.084;
[5] E. De Lena, M. Spinelli, I. Martinez, M. Gatti, R. Scaccabarozzi, G. Cinti, M. C. Romano, Process integration study of tail-end Ca-Looping process for CO₂capture in cement plants, Int. J. Greenh. Gas Control. 67 (2017) 71-92. doi:10.1016/j.ijggc.2017.10.005;
[6] D. C. Ozcan, H. Ahn, S. Brandani, Process integration of a Ca-looping carbon capture process in a cement plant, Int. J. Greenh. Gas Control. 19 (2013) 530-540. doi:10.1016/j.ijggc.2013.10.009;
[7] B. Arias, M. Alonso, C. Abanades, CO2 Capture by Calcium Looping at Relevant Conditions for Cement Plants: Experimental Testing in a 30 kW th Pilot Plant, Ind. Eng. Chem. Res. 56 (2017) 2634-2640. doi:10.1021/acs.iecr.6b04617;
[8] M. Hornberger, R. Spörl, G. Scheffknecht, Calcium Looping for CO2 Capture in Cement Plants—Pilot Scale Test, Energy Procedia. 114 (2017) 6171-6174. doi:10.1016/j.egypro.2017.03.1754;
[9] N. Rodriguez, R. Murillo, J. C. Abanades, CO2 Capture from Cement Plants Using Oxyfired Precalcination and/or Calcium Looping, Environ. Sci. Technol. 46 (2012) 2460-2466. doi:10.1021/es2030593;
[10] M. C. Romano, M. Spinelli, S. Campanari, S. Consonni, M. Marchi, N. Pimpinelli, G. Cinti, The Calcium looping process for low CO2 emission cement plants, in: Elsevier Ltd, 2014: pp. 500-503. doi:10.1016/j.egypro.2014.11.1158;
[11] E. De Lena, M. Spinelli, M. Gatti, R. Scaccabarozzi, S. Campanari, S. Consonni, G. Cinti, M. C. Romano, Techno-economic analysis of calcium looping processes for low CO2 emission cement plants, Int. J. Greenh. Gas Control. 82 (2019) 244-260. doi:10.1016/j.ijggc.2019.01.005;
[12] G. S. Grasa, J. C. Abanades, CO2 capture capacity of CaO in long series of carbonation/calcination cycles, Ind. Eng. Chem. Res. 45 (2006) 8846-8851. doi:10.1021/ie0606946.

1.-14. (canceled)

15. An assembly configured to reduce the emission of CO₂ of a plant for the production of clinkers, the assembly comprising:
two calciners and a carbonator arranged between the two calciners,
wherein one of the two calciners is an integral part of a clinker production system and is configured to continue to operate in a clinker production process even if a CO₂ capture system of the plant that uses the carbonator and the other calciner of the assembly is disconnected,
wherein said carbonator is free from recycle to both of said two calciners.

16. An assembly according to claim 15, wherein one of said two calciners is a primary calciner and precedes the carbonator, while the other calciner, arranged downstream of the carbonator is a secondary calciner.

17. A plant for the production of clinkers comprising both the assembly according to claim 15 and units of the clinker production plant.

18. A plant according to claim 17, including a carbonator, a primary calciner preceding the carbonator, or a secondary calciner positioned downstream of the carbonator, and, a sorbent cooler are configured to be disconnectable from one another in the event of malfunctions or maintenance, and reconnectable with one another after repair or after maintenance.

19. A plant according to claim 17, further comprising at least one preheater of a mineral raw flour located upstream of the primary calciner.

20. A plant according to claim 17, further comprising multiple pre-heaters of a mineral raw flour that are located upstream of the primary calciner and are arranged in parallel in several steps.

21. A plant according to claim 19, further comprising a raw mineral flour grinder located upstream of said at least one preheater.

22. A clinker production process configured to be conducted in a plant for the production of clinkers, the method comprising the following procedures:
a) a first calcination reaction carried out in a primary calciner on a preheated raw material stream to give a first stream of CO₂-enriched gas, which is removed and a first calcined material stream comprising CaO,
wherein the primary calciner is a first of two calciners of the plant, the primary calciner preceding a carbonator of the plant, the carbonator arranged between the two calciners;
wherein one of the two calciners is configured to continue to operate in a clinker production process even if a CO₂ capture system of the plant that uses the carbonator and the other calciner of the two calciners is disconnected;
wherein energy necessary to support the first calcination reaction is generated by an oxy-fuel combustion using as oxidizer a mixture formed by O₂ and by a part of the CO₂-enriched gas exiting from said primary calciner, in order to avoid dilution with nitrogen present in air;
b) cooling the first calcined material to produce cooled CaO-enriched calcined material;
c) a carbonation reaction performed with the cooled CaO-enriched calcined material to obtain calcium carbonate-enriched material;
d) a second calcination reaction conducted in a secondary calciner of the two calciners with calcium carbonate-enriched material produced during the procedure c) to generate a second stream of CO₂-enriched gas and a second stream of calcined material comprising CaO,
wherein the secondary calciner is arranged downstream of the carbonator;
wherein energy necessary to support the second calcination reaction is generated by an oxy-combustion using as oxidizer a mixture formed by O₂ and by a part of the second stream of CO₂-enriched gas exiting from the secondary calciner, in order to avoid dilution with nitrogen present in air;
e) transforming the calcined material comprising CaO of the second stream into clinker in a rotary kiln with the use of heat provided by combustion of at least one fuel and air, and
f) cooling a product produced by said transforming in a clinker cooler.

23. A clinker production process according to claim 22, wherein the first calcination reaction and the second calcination reaction are performed with a respective output temperature between 850° C. and 950° C.

24. A clinker production process according to claim 22, wherein said cooling the first calcined material includes cooling the first calcined material to a temperature between 55° and 650° C.

25. A clinker production process according to claim 22, wherein the carbonation reaction includes utilizing CO₂-enriched combustion gases formed in the rotary kiln during combustion in air.

26. A clinker production process according to claim 22, configured to be performed in said plant that has been complemented with multiple pre-heaters of a mineral raw flour that are located upstream of the primary calciner and that are arranged in parallel, the process further comprising:
cooling, in a pre-heater of the multiple pre-heaters, combustion gases formed in the rotary kiln during production of clinkers to obtained cooled combustion gases, and
sending the cooled combustion gases to the carbonator to be used in the carbonation reaction.

27. A clinker production process according to claim 22, further comprising:
feeding a raw material that is poor in calcium carbonate to the secondary calcinator.

28. A clinker production process according to claim 22, wherein the procedures d) and f) are performed while at least one of the carbonator and the primary calciner is disconnected due to malfunction or maintenance.

29. A clinker production process according to claim 22, wherein the cooling includes cooling the first calcined material in a sorbent cooler of the plant and/or in a carbonator equipped with an internal cooling system.
